(19) United States
(12) Patent Application Publication
(10) Pub. No.: US 2021/0053857 A1
(43) Pub. Date: Feb. 25, 2021

(54) DEVICES AND METHODS FOR HEATING MOLTEN MATERIAL

(71) Applicant: CORNING INCORPORATED, CORNING, NY (US)

(72) Inventor: RAYMOND EUGENE FRALEY, WAVERLY, NY (US)

(21) Appl. No.: 16/965,883

(22) PCT Filed: Jan. 28, 2019
(86) PCT No.: PCT/US2019/015398

§ 371 Date: Jul. 29, 2020

Related U.S. Application Data
(60) Provisional application No. 62/623,199, filed on Jan. 29, 2018.

(51) Int. Cl. C03B 5/027

(52) U.S. Cl. CPC C03B 5/027; C03B 17/064

(57) ABSTRACT

Heating devices can comprise an electrode, a bracket clamped to a rear end portion of the electrode, and a conductive panel comprising an inner face forced toward a rear face of the electrode by the bracket. In further embodiments, methods of assembling the heating device can comprise clamping the bracket to the rear end portion of the electrode and forcing the inner face of the conductive panel toward the rear face of the electrode with the bracket. In further embodiments, apparatus comprising the heating device can comprise a vessel with at least a portion of the electrode received within an opening of at least one wall. In further embodiments, methods can comprise heating molten material within a containment area of the vessel with the electrode and adjusting the position of the electrode relative to the opening of the wall.

### CROSS-REFERENCE To RELATED APPLICATION

This application claims the benefit of priority under 35 U.S.C. § 119 of U.S. Provisional Application Ser. No. 62/623199 filed on Jan. 29, 2018, the content of which is relied upon and incorporated herein by reference in its entirety.

### BACKGROUND

It is known to provide a glass manufacturing apparatus designed to produce a glass article from a quantity of molten material. Conventional glass manufacturing apparatus include a melting vessel including electrodes designed to process (e.g., melt, heat) batch material into a quantity of molten material.

### SUMMARY

The following presents a simplified summary of the disclosure to provide a basic understanding of some embodiments described in the detailed description.

The present disclosure relates generally to devices and methods for heating molten material and, more particularly, to devices and methods for heating molten material with an electrode.

In accordance with some embodiments, a heating device can comprise an electrode. The electrode can comprise a front end portion comprising a front face, a rear end portion comprising a rear face, and a length extending between the front face and the rear face. The heating device can further comprise a bracket clamped to the rear end portion of the electrode. The heating device can still further comprise a conductive panel comprising an inner face forced toward the rear face of the electrode by the bracket.

In one embodiment, the bracket can comprise at least two segments that may be adjustably fastened together to clamp the bracket to the rear end portion of the electrode.

In another embodiment, the bracket may be interlocked with the rear end portion of the electrode.

In another embodiment, the bracket can be interlocked with the rear end portion of the electrode by a tongue interlocked with a groove. In some embodiments, one of the bracket and the rear end portion of the electrode can comprise the tongue and the other of the bracket and the rear end portion of the electrode can comprise the groove.

In another embodiment, the bracket may clamp the rear end portion at a clamped area that may be entirely located less than or equal to 8 cm from the rear face of the electrode.

In another embodiment, a conductive pad may be forced against the rear face of the electrode by the inner face of the conductive panel.

In another embodiment, the electrode can comprise a cross-sectional footprint defined by an outermost profile of the electrode along a section taken perpendicular to the length of the electrode. In some embodiments, the bracket and the conductive panel may be each located entirely within a projection of the footprint of the electrode in a direction of the length of the electrode.

In another embodiment, the conductive panel can be adjustably fastened to the bracket to force the inner face of the conductive panel toward the rear face of the electrode.

In another embodiment, the conductive panel can comprise a fluid coolant path extending through an interior of the conductive panel.

In another embodiment, a method of assembling the heating device can comprise clamping the bracket to the rear end portion of the electrode. The method of assembling can further include forcing the inner face of the conductive panel toward the rear face of the electrode with the bracket.

In another embodiment of the method of assembling, the bracket may clamp the rear end portion at a clamped area that can be entirely located less than or equal to 8 cm from the rear face of the electrode.

In another embodiment of the method of assembling, the forcing of the inner face of the conductive panel toward the rear face of the electrode can at least partially collapse a conductive pad contacting the rear face of the electrode and the inner face of the conductive panel.

In another embodiment of the method of assembling, the electrode can comprise a cross-sectional footprint defined by an outermost profile of the electrode along a section taken perpendicular to the length of the electrode. In some embodiments, the bracket and the conductive panel can be each located entirely within a projection of the footprint of the electrode in a direction of the length of the electrode.

In another embodiment, an apparatus comprising the heating device can comprise a vessel. The vessel can comprise at least one wall defining a containment area of the vessel. The at least one wall can comprise an opening receiving at least a portion of the electrode.

In another embodiment, a position of the electrode can be adjustable relative to the opening of the wall.

In another embodiment, the frame and the conductive panel can be received within the opening of the wall.

In another embodiment, the vessel can comprise a melting vessel of a glass manufacturing apparatus.

In another embodiment, a method of using the apparatus can comprise heating molten material within the containment area of the vessel by passing electrical current through the molten material with the electrode. The method of using the apparatus can further comprise adjusting the position of the electrode relative to the opening of the wall.

In another embodiment, the method of using the apparatus can position both the frame and the conductive panel within the opening of the wall while adjusting a position of the electrode relative to the opening of the wall.

In another embodiment, the method of using the apparatus can further comprise removing the frame and the conductive panel from the adjusted electrode. The method of using the apparatus can then further comprise pressing another electrode against the adjusted electrode to further adjust the position of the adjusted electrode relative to the opening of the wall.

It is to be understood that both the foregoing general description and the following detailed description present embodiments of the present disclosure, and are intended to provide an overview or framework for understanding the nature and character of the embodiments as they are described and claimed. The accompanying drawings are included to provide a further understanding of the embodiments, and are incorporated into and constitute a part of this specification. The drawings illustrate various embodiments of the disclosure, and together with the description serve to explain the principles and operations thereof.

### BRIEF DESCRIPTION OF THE DRAWINGS

These and other features, embodiments and advantages of the present disclosure can be further understood when read with reference to the accompanying drawings, in which:

FIG. 1 schematically illustrates an exemplary embodiment of a glass manufacturing apparatus in accordance with embodiments of the disclosure;

FIG. 2 shows a perspective cross-sectional view of the glass manufacturing apparatus along line 2-2 of FIG. 1 in accordance with embodiments of the disclosure;

FIG. 3 shows a schematic view of a portion of the glass manufacturing apparatus along line 3-3 of FIG. 1 in accordance with embodiments of the disclosure;

FIG. 4 shows a schematic cross-sectional view of the glass manufacturing apparatus along line 4-4 of FIG. 3 in accordance with embodiments of the disclosure;

FIG. 5 shows a rear view of an electrode in accordance with embodiments of the disclosure;

FIG. 6 shows a side view of the electrode of FIG. 5;

FIG. 7 shows a top view of the electrode of FIG. 6;

FIG. 8 shows a sectional view of the electrode along line 8A-8A of FIG. 5, wherein, except for the pin, the section along line 8B-8B of FIG. 5 would appear as FIG. 8 rotated 90° clockwise, the section along line 8C-8C of FIG. 5 would appear as FIG. 8 rotated 180°; and the section along line 8D-8D of FIG. 5 would appear as FIG. 8 rotated 90° counterclockwise;

FIG. 9 shows a rear view of the electrode of FIG. 5 with an exemplary conductive pad positioned adjacent a rear face of a rear end portion of the electrode;

FIG. 10 shows a sectional view of the electrode and conductive pad along line 10A-10A of FIG. 9, wherein, except for the pin, the section along line 10B-10B of FIG. 9 would appear as FIG. 10 rotated 90° clockwise, the section along line 10C-10C of FIG. 9 would appear as FIG. 10 rotated 180°; and the section along line 10D-10D of FIG. 9 would appear as FIG. 10 rotated 90° counterclockwise;

FIG. 11 a rear view of the electrode and conductive pad of FIG. 9 with an exemplary bracket clamped to the rear end portion of the electrode;

FIG. 12 shows a sectional view of the electrode, conductive pad and bracket along line 12A-12A of FIG. 11, wherein, except for the pin, the section along line 12B-12B of FIG. 11 would appear as FIG. 12 rotated 180°;

FIG. 13 shows a sectional view of the electrode, conductive pad and bracket along line 13A-13A of FIG. 11, wherein the section along line 13B-13B of FIG. 11 would appear as FIG. 13 rotated 180°;

FIG. 14 shows a rear view of the electrode, conductive pad and bracket of FIG. 11 with an exemplary conductive panel forced toward the electrode by the bracket;

FIG. 15 shows a sectional view of the electrode, conductive pad, bracket and conductive panel along line 15A-15A of FIG. 14, wherein, except for the pin, the section along line 15B-15B of FIG. 14 would appear as FIG. 15 rotated 180°;

FIG. 16 shows a sectional view of the electrode, conductive pad, bracket and conductive panel along line 16A-16A of FIG. 14, wherein the section along line 16B-16B of FIG. 14 would appear as FIG. 16 rotated 180°;

FIG. 17 shows a rear view of another embodiment of a conductive panel;

FIG. 18 shows a sectional view of the conductive panel along line 18-18 of FIG. 17;

FIG. 19 shows a rear view of the conductive panel of FIG. 17 with the rear plate of the conductive panel removed;

FIG. 20 shows another embodiment of an electrode, the exemplary conductive pad of FIG. 9 positioned adjacent a rear face of a rear end portion of the electrode, and another embodiment of a conductive panel positioned relative to the rear face of the rear end portion of the electrode;

FIG. 21 shows a sectional view of the electrode, the conductive pad and the conductive panel along line 21A-21A of FIG. 20, wherein the section along line 21B-21B of FIG. 20 would appear as FIG. 21 rotated 90° clockwise, the section along line 21C-21C of FIG. 20 would appear as FIG. 21 rotated 180°; and the section along line 21D-21D of FIG. 20 would appear as FIG. 21 rotated 90° counterclockwise;

FIG. 22 shows the electrode, the conductive pad, and the conductive panel of FIG. 20 and another embodiment of a bracket clamped to the rear end portion of the electrode;

FIG. 23 shows a sectional view of the electrode, conductive pad, bracket and conductive panel along line 23A-23A of FIG. 22, wherein the section along line 23B-23B of FIG. 22 would appear as FIG. 23 rotated 180°;

FIG. 24 shows a sectional view of the electrode, conductive pad, bracket and conductive panel along line 24A-24A of FIG. 22, wherein the section along line 24B-24B of FIG. 22 would appear as FIG. 24 rotated 180°;

FIG. 25 shows a partial sectional view of the first electrode positioned within the first opening of the melting vessel;

FIG. 26 shows the electrode of the partial sectional view of FIG. 25 with the conductive panel, conductive pad and bracket removed; and

FIG. 27 shows the electrode of FIG. 26 with another electrode at least partially inserted into the first opening of the melting vessel.

### DETAILED DESCRIPTION

Embodiments will now be described more fully hereinafter with reference to the accompanying drawings in which exemplary embodiments are shown. Whenever possible, the same reference numerals are used throughout the drawings to refer to the same or like parts. However, this disclosure may be embodied in many different forms and should not be construed as limited to the embodiments set forth herein.

It is to be understood that specific embodiments disclosed herein are intended to be exemplary and therefore non-limiting. For purposes of the disclosure, in some embodiments, a glass manufacturing apparatus can optionally include a glass forming apparatus that forms a glass article (e.g., a glass ribbon and/or a glass sheet) from a quantity of molten material. For instance, in some embodiments, the glass manufacturing apparatus can optionally comprise a glass forming apparatus such as a slot draw apparatus, float bath apparatus, down-draw apparatus, up-draw apparatus, press-rolling apparatus, or other glass forming apparatus that forms a glass article. In some embodiments, the glass article can be employed in a variety of articles having desired optical characteristics (e.g., ophthalmic articles, display articles). For instance, in some embodiments, the apparatus can be employed to produce display articles (e.g., display glass sheets) that may be used in a wide variety of display applications including, but not limited to, liquid crystal displays (LCDs), electrophoretic displays (EPD), organic light emitting diode displays (OLEDs), plasma display panels (PDPs), and other electronic displays.

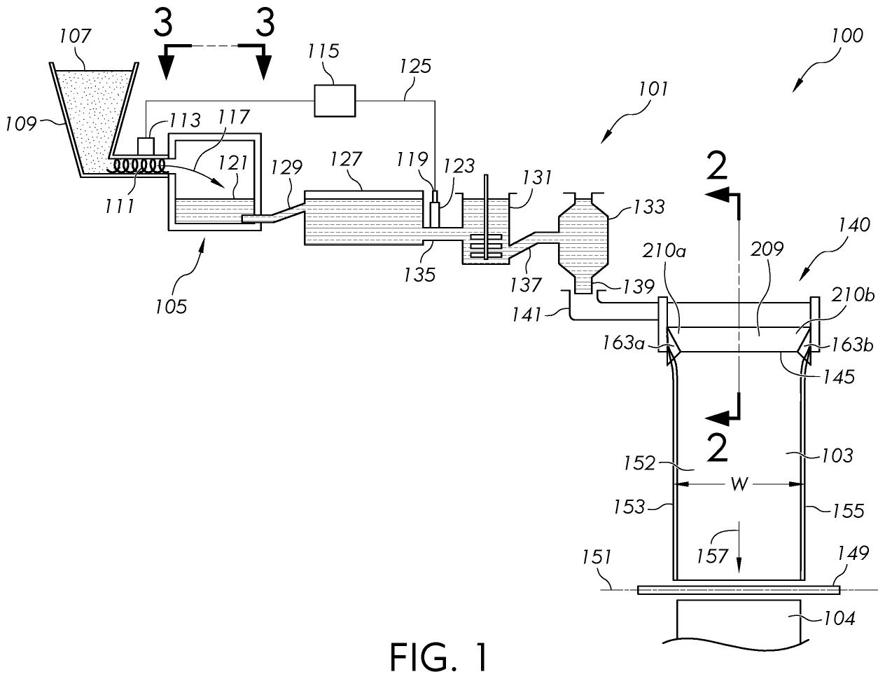

As schematically illustrated in FIG. 1, in some embodiments, an exemplary glass manufacturing apparatus 100 can include a glass forming apparatus 101 including a forming vessel 140 designed to produce a glass ribbon 103 from a quantity of molten material 121. In some embodiments, the glass ribbon 103 can include a central portion 152 disposed between opposite, relatively thick edge beads formed along a first outer edge 153 and a second outer edge 155 of the glass ribbon 103. Additionally, in some embodiments, a glass sheet 104 can be separated from the glass ribbon 103 along a separation path 151 by a glass separator 149 (e.g., scribe, score wheel, diamond tip, laser, etc.). In some embodiments, before or after separation of the glass sheet 104 from the glass ribbon 103, the relatively thick edge beads formed along the first outer edge 153 and the second outer edge 155 can be removed to provide the central portion 152 as a high-quality glass sheet 104 having a uniform thickness. In some embodiments, the resulting high-quality glass sheet 104 can then be at least one of processed and employed in a variety of applications.

In some embodiments, the glass manufacturing apparatus 100 can include a melting vessel 105 oriented to receive batch material 107 from a storage bin 109. The batch material 107 can be introduced by a batch delivery device 111 powered by a motor 113. In some embodiments, an optional controller 115 can be operated to activate the motor 113 to introduce a desired amount of batch material 107 into the melting vessel 105, as indicated by arrow 117. The melting vessel 105 can heat the batch material 107 to provide molten material 121. In some embodiments, a glass melt probe 119 can be employed to measure a level of molten material 121 within a standpipe 123 and communicate the measured information to the controller 115 by way of a communication line 125.

Additionally, in some embodiments, the glass manufacturing apparatus 100 can include a first conditioning station including a fining vessel 127 located downstream from the melting vessel 105 and coupled to the melting vessel 105 by way of a first connecting conduit 129. In some embodiments, molten material 121 can be gravity fed from the melting vessel 105 to the fining vessel 127 by way of the first connecting conduit 129. For example, in some embodiments, gravity can drive the molten material 121 to pass through an interior pathway of the first connecting conduit 129 from the melting vessel 105 to the fining vessel 127. Additionally, in some embodiments, bubbles can be removed from the molten material 121 within the fining vessel 127 by various techniques.

In some embodiments, the glass manufacturing apparatus 100 can further include a second conditioning station including a mixing chamber 131 that can be located downstream from the fining vessel 127. The mixing chamber 131 can be employed to provide a homogenous composition of molten material 121, thereby reducing or eliminating inhomogeneity that may otherwise exist within the molten material 121 exiting the fining vessel 127. As shown, the fining vessel 127 can be coupled to the mixing chamber 131 by way of a second connecting conduit 135. In some embodiments, molten material 121 can be gravity fed from the fining vessel 127 to the mixing chamber 131 by way of the second connecting conduit 135. For example, in some embodiments, gravity can drive the molten material 121 to pass through an interior pathway of the second connecting conduit 135 from the fining vessel 127 to the mixing chamber 131.

Additionally, in some embodiments, the glass manufacturing apparatus 100 can include a third conditioning station including a delivery vessel 133 that can be located downstream from the mixing chamber 131. In some embodiments, the delivery vessel 133 can condition the molten material 121 to be fed into an inlet conduit 141. For example, the delivery vessel 133 can function as an accumulator and/or flow controller to adjust and provide a consistent flow of molten material 121 to the inlet conduit 141. As shown, the mixing chamber 131 can be coupled to the delivery vessel 133 by way of a third connecting conduit 137. In some embodiments, molten material 121 can be gravity fed from the mixing chamber 131 to the delivery vessel 133 by way of the third connecting conduit 137. For example, in some embodiments, gravity can drive the molten material 121 to pass through an interior pathway of the third connecting conduit 137 from the mixing chamber 131 to the delivery vessel 133. As further illustrated, in some embodiments, a delivery pipe 139 (e.g., downcomer) can be positioned to deliver molten material 121 to the inlet conduit 141 of the forming vessel 140.

Various embodiments of forming vessels can be provided in accordance with features of the disclosure including a forming vessel with a wedge for fusion drawing the glass ribbon, a forming vessel with a slot to slot draw the glass ribbon, or a forming vessel provided with press rolls to press roll the glass ribbon from the forming vessel. By way of illustration, the forming vessel 140 shown and disclosed below can be provided to fusion draw molten material 121 off a root 145 of a forming wedge 209 to produce the glass ribbon 103. For example, in some embodiments, the molten material 121 can be delivered from the inlet conduit 141 to the forming vessel 140. The molten material 121 can then be formed into the glass ribbon 103 based at least in part on the structure of the forming vessel 140. For example, as shown, the molten material 121 can be drawn off the bottom edge (e.g., root 145) of the forming vessel 140 along a draw path extending in a draw direction 157 of the glass manufacturing apparatus 100. In some embodiments, edge directors 163a, 163b can direct the molten material 121 off the forming vessel 140 and define, at least in part, a width “W” of the glass ribbon 103. In some embodiments, the width “W” of the glass ribbon 103 can extend between the first outer edge 153 of the glass ribbon 103 and the second outer edge 155 of the glass ribbon 103.

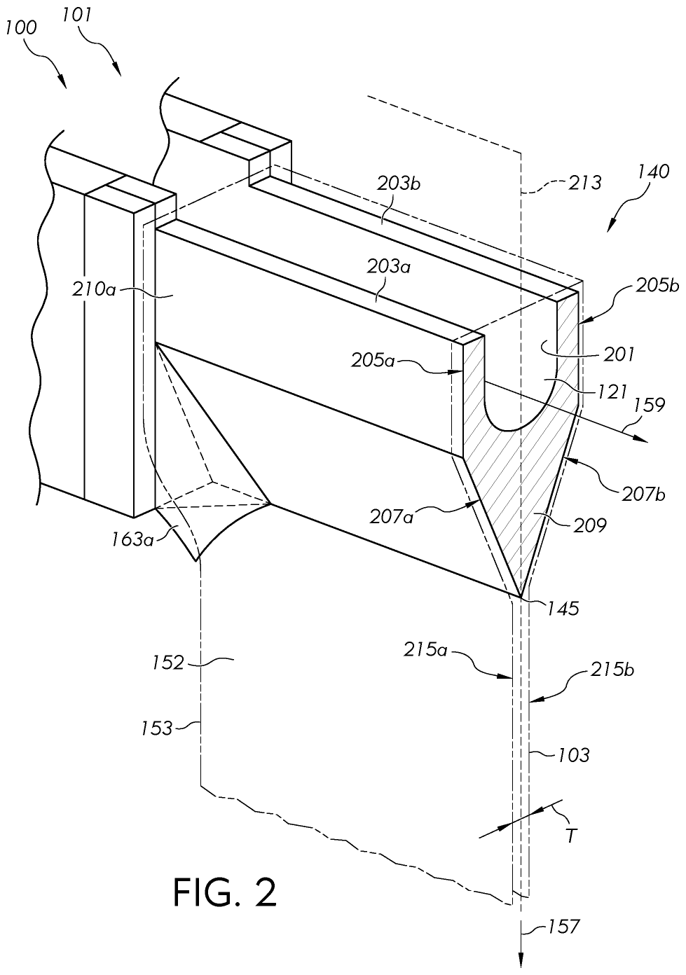

FIG. 2 shows a cross-sectional perspective view of the glass manufacturing apparatus 100 along line 2-2 of FIG. 1. In some embodiments, the forming vessel 140 can include a trough 201 oriented to receive the molten material 121 from the inlet conduit 141. For illustrative purposes, cross-hatching of the molten material 121 is removed from FIG. 2 for clarity. The forming vessel 140 can further include the forming wedge 209 including a pair of downwardly inclined converging surface portions 207a, 207b extending between opposed ends 210a, 210b (See FIG. 1) of the forming wedge 209. The pair of downwardly inclined converging surface portions 207a, 207b of the forming wedge 209 can converge along the draw direction 157 to intersect along a bottom edge of the forming wedge 209 to define the root 145 of the forming vessel 140. A draw plane 213 of the glass manufacturing apparatus 100 can extend through the root 145 along the draw direction 157. In some embodiments, the glass ribbon 103 can be drawn in the draw direction 157 along the draw plane 213. As shown, the draw plane 213 can bisect the root 145 although, in some embodiments, the draw plane 213 can extend at other orientations relative to the root 145.

Additionally, in some embodiments, the molten material 121 can flow in a direction 159 into the trough 201 of the forming vessel 140. The molten material 121 can then overflow from the trough 201 by simultaneously flowing over corresponding weirs 203a, 203b and downward over the outer surfaces 205a, 205b of the corresponding weirs 203a, 203b. Respective streams of molten material 121 can then flow along the downwardly inclined converging surface portions 207a, 207b of the forming wedge 209 to be drawn off the root 145 of the forming vessel 140, where the flows converge and fuse into the glass ribbon 103. The glass ribbon 103 can then be fusion drawn off the root 145 in the draw plane 213 along the draw direction 157. In some embodiments, the glass separator 149 (see FIG. 1) can then subsequently separate the glass sheet 104 from the glass ribbon 103 along the separation path 151. As illustrated, in some embodiments, the separation path 151 can extend along the width “W” of the glass ribbon 103 between the first outer edge 153 and the second outer edge 155. Additionally, in some embodiments, the separation path 151 can extend substantially perpendicular to the draw direction 157 of the glass ribbon 103. Moreover, in some embodiments, the draw direction 157 can be a fusion draw direction of the glass ribbon 103 being fusion drawn from the forming vessel 140.

As shown in FIG. 2, the glass ribbon 103 can be drawn from the root 145 with a first major surface 215a of the glass ribbon 103 and a second major surface 215b of the glass ribbon 103 facing opposite directions and defining a thickness “T” (e.g., average thickness) of the glass ribbon 103. In some embodiments, the thickness “T” of the glass ribbon 103 can be less than or equal to about 2 millimeters (mm), less than or equal to about 1 millimeter, less than or equal to about 0.5 millimeters, less than or equal to about 500 micrometers (μm), for example, less than or equal to about 300 μm, less than or equal to about 200 μm, or less than or equal to about 100 μm, although other thicknesses may be provided in further embodiments. For example, in some embodiments, the thickness “T” of the glass ribbon 103 can be from about 50 μm to about 750 μm, from about 100 μm to about 700 μm, from about 200 μm to about 600 μm, from about 300 μm to about 500 μm, from about 50 μm to about 500 μm, from about 50 μm to about 700 μm, from about 50 μm to about 600 μm, from about 50 μm to about 500 μm, from about 50 μm to about 400 μm, from about 50 μm to about 300 μm, from about 50 μm to about 200 μm, from about 50 μm to about 100 μm, including all ranges and subranges of thicknesses therebetween. In addition, the glass ribbon 103 can include a variety of compositions including, but not limited to, soda-lime glass, borosilicate glass, alumino-borosilicate glass, alkali-containing glass or alkali-free glass.

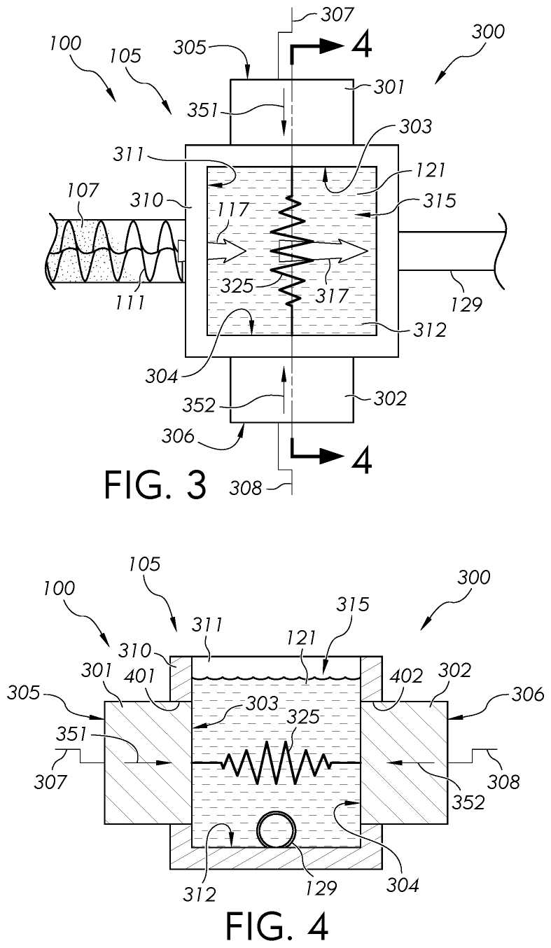

FIG. 3 shows a plan view of a portion of the glass manufacturing apparatus 100 including the melting vessel 105 along line 3-3 of FIG. 1, with a top portion (e.g., lid, roof, ceiling) of the melting vessel 105 removed for clarity. Thus, unless otherwise noted, it is to be understood that, in some embodiments, the melting vessel 105 can include a fixed or removable top portion without departing from the scope of the disclosure. Additionally, unless otherwise noted, in some embodiments, the top portion of the melting vessel 105 can be open to, for example, the environment outside of the melting vessel 105, and a free surface of the molten material 121 can face the open top portion. In some embodiments, the melting vessel 105 can include a wall 310 including an inner surface 311, 312 defining, at least in part, a containment area 315 (e.g., a volume) of the melting vessel 105. For example, in some embodiments, a sidewall inner surface 311 and a bottom wall inner surface 312 can define, at least in part, the containment area 315 of the melting vessel 105. As shown, in some embodiments, the containment area 315 can contain material (e.g., batch material 107, molten material 121); however, unless otherwise noted, it is to be understood that the melting vessel 105 can be empty (e.g., provided without material) in some embodiments, without departing from the scope of the disclosure.

In some embodiments, the wall 310 of the melting vessel 105 can include (e.g., be manufactured from) metallic and/or non-metallic materials including but not limited to one or more of a thermal insulating refractory material (e.g., ceramic, silicon carbide, zirconia, zircon, chromium oxide). Additionally, in some embodiments the inner surface 311, 312 of the melting vessel 105 can include a layer (not shown) of corrosion resistant material (e.g., platinum, platinum alloys) to provide a corrosion resistant barrier between the material 107, 121 contained within the containment area 315 and the wall 310. In some embodiments, the wall 310 of the melting vessel 105 can include material selected to resist structural degradation and deformation (e.g., warp, sag, creep, fatigue, corrosion, breakage, cracking, thermal shock, structural shock, etc.) caused by exposure to one or more of an elevated temperature (e.g., temperatures at or below 2100° C.), a corrosive chemical (e.g., boron, phosphorus, sodium oxide), and an external force. In some embodiments, the wall 310 can be manufactured as a solid monolithic structure; however, in some embodiments, a plurality of separate structures (e.g., bricks) can be combined (e.g., stacked) to provide at least a portion of the wall 310. For purposes of the disclosure, irrespective of the manner in which the wall 310 is constructed, a containment vessel can be provided with inner surface 311, 312 defining at least a portion of a containment area 315 oriented to contain material 107, 121 within the containment area 315.

As indicated by arrow 117, in some embodiments, the batch material 107 can be introduced by the batch delivery device 111 into the containment area 315 of the melting vessel 105. In some embodiments, the melting vessel 105 can heat the batch material 107 to provide molten material 121 within the containment area 315. In further embodiments, the melting vessel 105 may be operable to raise or lower the temperature of a molten material contained within the containment area 315. For example, in some embodiments, the glass manufacturing apparatus 100 can include a heating device 300 that can include, in some embodiments, a first electrode 301 and a second electrode 302 operable to heat (e.g., melt) the batch material 107 to provide molten material 121. In some embodiments, the first electrode 301 and the second electrode 302 can be identical to one another. As such, discussion throughout the disclosure features of the first electrode 301 can be identical to features of the second electrode 302. In further embodiments, structures associated and/or operable with the first electrode 301 can be identical to structures associated and/or operable with the second electrode 302. As such, discussion throughout the disclosure of the features of the first electrode 301 and structures associated and/or operable with the first electrode 301 can equally apply to the features of the second electrode 302 and structures associated and/or operable with the second electrode 302. Furthermore, although not shown, features of the second electrode 302 and/or structures associated and/or operable with the second electrode 302 may not be identical to corresponding features of the first electrode 301 and/or corresponding structures associated with the first electrode 301.

In some embodiments, one or more further heating devices (not shown) can be provided to, for example, initially melt the batch material 107 to provide the molten material 121, and then the heating device 300 can be employed to further melt the batch material 107 and/or further heat the molten material 121. Moreover, in some embodiments one or more additional heating devices (not shown) including but not limited to gas heaters, electric heaters, and resistance heaters can be provided to provide additional heat to the material 107, 121 contained within the containment area 315 of the melting vessel 105 without departing from the scope of the disclosure.

In some embodiments, a heating electrical circuit including a first electrical lead 307 electrically connected to the first electrode 301 and a second electrical lead 308 electrically connected to the second electrode 302. In some embodiments, the material (e.g., batch material 107, molten material 121) can include material properties that cause the material to behave as an electrical resistor which converts an electric current 325 passing through the material 107, 121 into heat energy based at least on the principle of Joule heating. Accordingly, in some embodiments, the Joule heating can be based at least in part on the Joule law (P=I²×R), where “P” is the electrical heating power, “I” is the electric current 325, and “R” is the electrical resistivity of the material through which the electric current 325 passes. For example, in some embodiments, electric current 325 can pass from a front face 303 of the first electrode 301, through the material 107, 121 contained in the containment area 315, to a front face 304 of the second electrode 302. Likewise, in some embodiments, electric current 325 can pass from the front face 304 of the second electrode 302, through the material 107, 121 contained in the containment area 315, to the front face 303 of the first electrode 301. Accordingly, in some embodiments, based at least in part on the conversion of the electric current 325 into heat energy, one or more features of the heating device 300 can operate to increase a temperature of the material 107, 121 and/or maintain a temperature of the material 107, 121 contained within the containment area 315.

In some embodiments, the heating device 300 can, therefore, be employed to, for example, at least one of control and reduce temperature fluctuations and temperature gradients of the material 107, 121 contained within the containment area 315 of the melting vessel 105. For example, in some embodiments, one or more features of the heating device 300 can uniformly heat the batch material 107 to provide the molten material 121 contained within the melting vessel 105 with a uniform, controlled temperature. The uniform, controlled temperature of the molten material 121 can, in some embodiments, provide a better quality glass ribbon 103 relative to glass ribbons formed with molten material 121 that includes temperature gradients and/or temperature fluctuations. For example, as indicated by arrow 317, in some embodiments, the molten material 121 can flow through the containment area 315 to the first connecting conduit 129 (e.g., across the electric current 325) while being heated by the heating device 300. In some embodiments, the molten material 121 can then be provided to the glass forming apparatus 101 for further processing to, for example, form the glass ribbon 103 (See FIG. 1).

In some embodiments, at least one of the first electrode 301 and the second electrode 302 can include (e.g., be manufactured from) metallic and/or non-metallic materials including but not limited to one or more of tin oxide, carbon, zirconia, molybdenum, platinum, and platinum alloys. In some embodiments, the front face 303 of the first electrode 301 and the front face 304 of the second electrode 302 can contact the material 107, 121 contained within the containment area 315 of the melting vessel 105. Accordingly, in some embodiments, at least one of the first electrode 301 and the second electrode 302 can include material selected to resist structural degradation and deformation (e.g., warp, sag, creep, fatigue, corrosion, breakage, cracking, thermal shock, structural shock, etc.) caused by exposure to one or more of an elevated temperature (e.g., temperatures at or below 2100° C.), a corrosive chemical (e.g., boron, phosphorus, sodium oxide), and an external force. Moreover, in some embodiments, at least one of the first electrode 301 and the second electrode 302 can be manufactured as a single monolithic structure; however, as shown, in some embodiments, a plurality of separate structures (e.g., bricks) can be combined (e.g., stacked) to provide at least a portion of at least one of the first electrode 301 and the second electrode 302. Building the electrode from a plurality of separate structures (e.g., bricks) can help simplify and reduce costs of fabrication of the electrode.

In some embodiments, based at least on the heat energy provided by electric current 325, a temperature of a rear face 305 of the first electrode 301 can be less than a temperature of the front face 303 of the first electrode 301. Likewise, in some embodiments, based at least on the heat energy provided by electric current 325, a temperature of a rear face 306 of the second electrode 302 can be less than a temperature of the front face 304 of the second electrode 302.

As further illustrated in FIG. 4, which shows a cross-sectional view of the melting vessel 105 along line 4-4 of FIG. 3, in some embodiments the first electrode 301 can be positioned in a first opening 401 in the wall 310 of the melting vessel 105, and the second electrode 302 can be positioned in a second opening 402 in the wall 310 of the melting vessel 105. In some embodiments, the first opening 401 can be positioned opposite the second opening 402. In some embodiments, as shown, the first opening 401 and the second opening 402 can be aligned along a common axis. As further shown, in some embodiments, the front face 303 of the first electrode 301 can face the front face 304 of the second electrode 302 with the front faces 303, 304 contacting the material 107, 121 contained within the containment area 315 of the melting vessel 105. Accordingly, in some embodiments, electric current 325 can pass from the front face 303 of the first electrode 301 positioned in the first opening 401 through the material 107, 121 contained in the containment area 315, to the front face 304 of the second electrode 302 positioned in the second opening 402. Likewise, in some embodiments, electric current 325 can pass from the front face 304 of the second electrode 302 positioned in the second opening 402, through the material 107, 121 contained in the containment area 315, to the front face 303 of the first electrode 301 positioned in the first opening 401.

In some embodiments, at least one of the front face 303 of the first electrode 301 and the front face 304 of the second electrode 302 can wear (e.g., degrade, reduce), for example, over a duration of time based at least on operation of the heating device 300 and contact with the material 107, 121. Accordingly, as discussed more fully below, in some embodiments, the first electrode 301 can be adjusted relative to the first opening 401 to translate the front face 303 along an adjustment path in the direction 351, thereby compensating for the structural degradation of the front face 303 caused by wear while operating the glass manufacturing apparatus 100. Likewise, as discussed more fully below, in some embodiments, the second electrode 302 can be can be adjusted relative to the second opening 404 to translate the front face 304 along an adjustment path in the direction 352, thereby compensating for the structural degradation of the front face 304 caused by wear while operating the glass manufacturing apparatus 100. In some embodiments, the inner surface 311, 312 of the wall 310 as well as the front face 303 of the first electrode 301 and the front face 304 of the second electrode 302 can define, at least in part, the containment area 315 of the melting vessel 105. Accordingly, in some embodiments, based at least in part on the conversion of the electric current 325 into heat energy, one or more features of the heating device 300 can operate to increase a temperature of the material 107, 121 and/or maintain a temperature of the material 107, 121 contained within the containment area 315.

Although described with respect to features of the melting vessel 105, unless otherwise noted, it is to be understood that, in some embodiments, one or more features of the heating device 300 can be provided, alone or in combination, with one or more vessels, including vessels not explicitly disclosed. In some embodiments, material (e.g., molten material) can be heated while being contained within a containment area of the vessel. Exemplary vessels employing the heating device can process molten material in a wide range of ways including but not limited to fining, conditioning, containing, stirring, allowing to chemically react, bubbling a gas therein, cooling, heating, forming, holding and flowing. In some embodiments, with respect to the glass manufacturing apparatus 100 of FIG. 1, the vessel employing the heating device 300 can include, but is not limited to, the melting vessel 105, first connecting conduit 129, fining vessel 127, the standpipe 123, the second connecting conduit 135, the mixing chamber 131, the third connecting conduit 137, the delivery vessel 133, the delivery pipe 139, the inlet conduit 141 and the forming vessel 140. Moreover, as shown in FIGS. 3 and 4, although melting vessel 105 is illustrated with a wall 310 that has a substantially cubic structure, unless otherwise noted, it is to be understood that, in some embodiments, the melting vessel 105 or other vessels incorporating the heating device 300 can include a wall that defines one or more profiles and shapes including but not limited to, a sphere, a rectangular box, a cylinder, a cone, or other three-dimensional shape oriented to include a containment area (e.g., volume) to contain material.

Exemplary embodiments of an exemplary heating device 300 will now be described with respect to heating molten material 121 contained within the containment area 315 of the melting vessel 105 with the understanding that, unless otherwise noted, one or more features of the heating device 300 can be employed, alone or in combination, in some embodiments, to heat material contained within a containment area of other vessels in accordance with embodiments of the disclosure, without departing from the scope of the disclosure.

The heating device 300 may include a wide range of configurations. In some embodiments, the electrode 301 and features associated with the first electrode 301 can be identical to the second electrode 302 and/or features associated with the second electrode 302. As such, embodiments of the electrodes 301, 302 and structures associated with the electrodes 301, 302 will be discussed with reference to the first electrode 301 with the understanding that such discussion can equally apply to the second electrode 302.

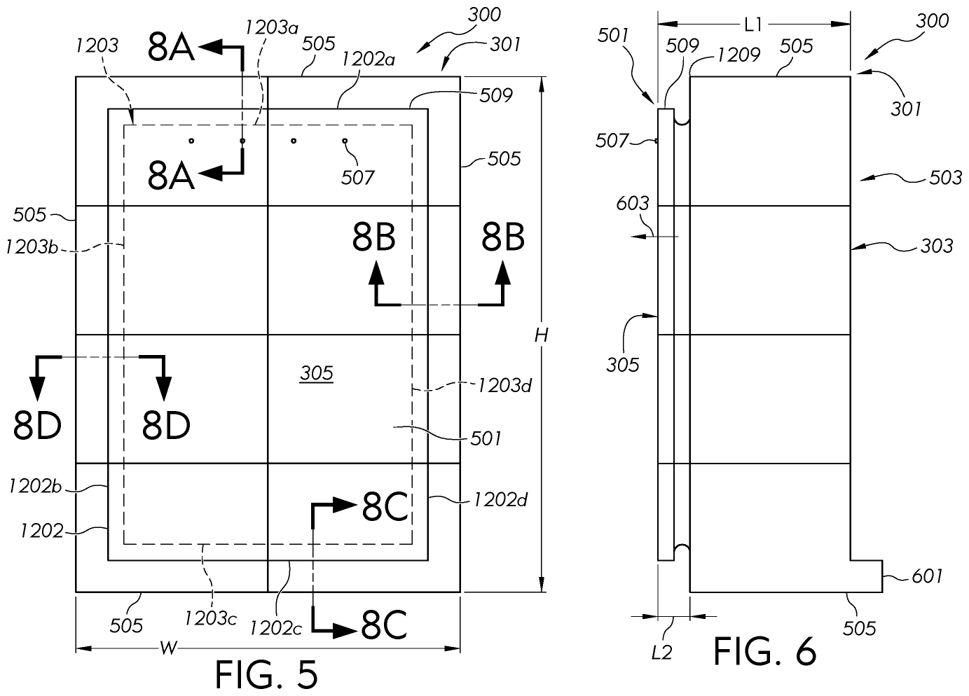

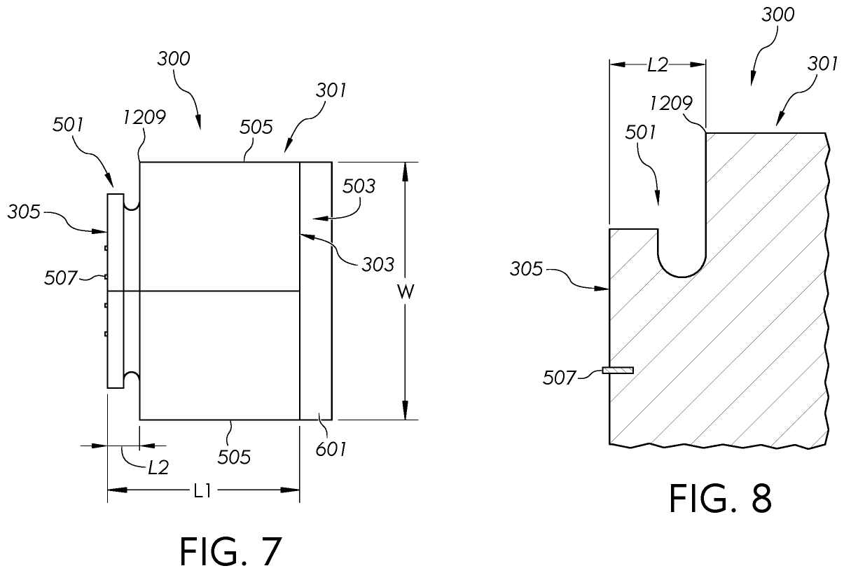

As shown in FIGS. 5-8, the heating device 300 can comprise the first electrode 301. In some embodiments, the first electrode 301 can comprise a rear end portion 501 that can include a rear face 305. As shown in FIGS. 6 and 7, the first electrode 301 can further include a front end portion 503 that can include the front face 303. As shown, the front face 303 and the rear face 305 can be substantially parallel and planar surfaces although other alternative surface characteristics or relative orientations may be provided in further embodiments. The first electrode 301 can further include a length “L1” extending between the front face 303 and the rear face 305. As shown in FIG. 6, the first electrode may include a lower protrusion 601. As shown in FIG. 7, in some embodiments, the lower protrusion 601 can extend across the overall width “W” of the first electrode 301. As shown in FIGS. 5-7, the first electrode 301 can further comprise a cross-sectional footprint defined by an outermost profile 505 of the first electrode 301 along a section taken perpendicular to the length “L1” of the first electrode 301. The cross-sectional footprint can have an area defined by the overall width “W” multiplied by the overall height “H” at the outermost profile 505 of the first electrode 301. In some embodiments, the dimensions and area of the cross-sectional footprint of the first electrode 301 can substantially match corresponding dimensions and area of the cross-section of the first opening 401 taken perpendicular to the direction 351 to allow the first electrode 301 to be adjusted relative to the first opening 401 along direction 351.

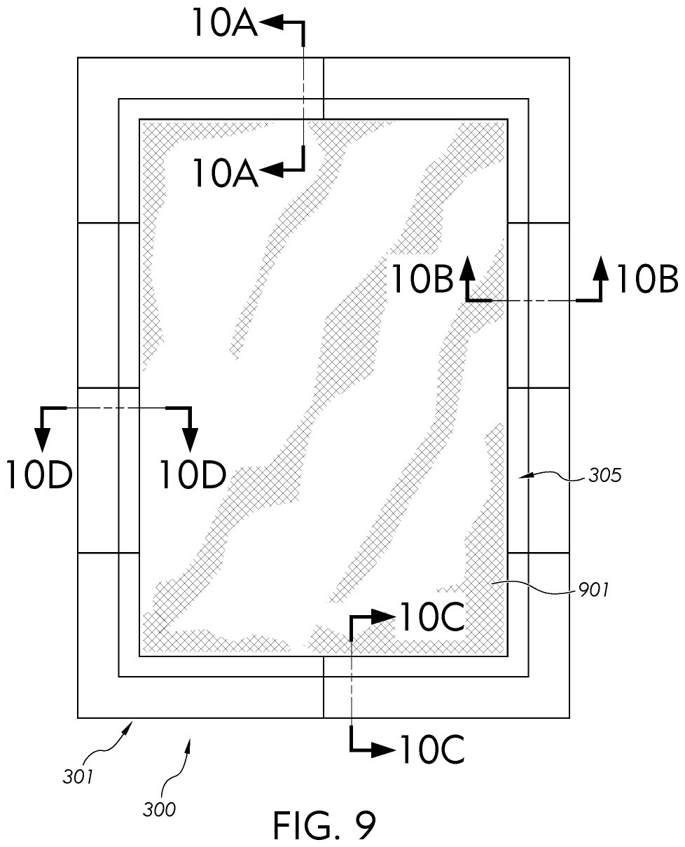

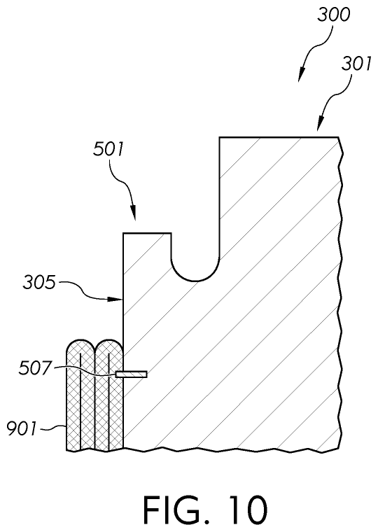

As shown in FIGS. 9-10, in some embodiments, a conductive pad 901 can be positioned relative to the rear face 305 of the first electrode 301. In some embodiments, the conductive pad 901 can comprise a mesh, such as the 4 ply mesh illustrated in FIG. 10. Providing the conductive pad 901 as a mesh of material can provide a pad that can be easily collapsed upon application of an appropriate level of pressure. The act of collapsing the conductive pad can help confirm the conductive pad to opposed surfaces compressing the conductive pad. As such, the integrity of the electrical connection between the opposed surfaces can be improved. In some embodiments, the conductive pad 901 can comprise silver although other conductive metals such as platinum or copper may be provided in further embodiments.

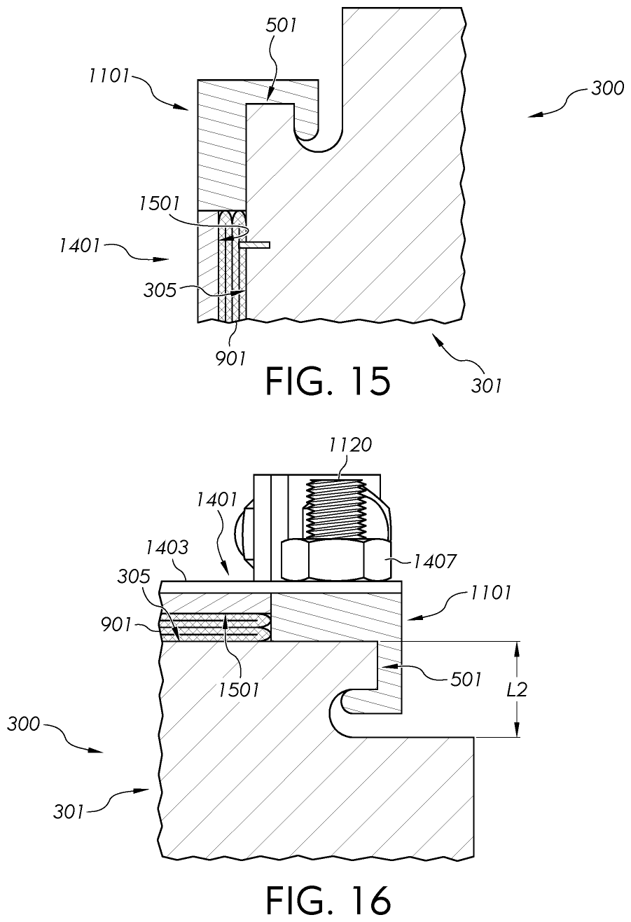

As shown in FIGS. 15 and 16, the conductive pad 901, if provided, may be positioned between a conductive panel 1401 and the first electrode 301 to provide an electrical connection between the conductive panel 1401 and the first electrode 301. As further illustrated in FIGS. 15 and 16, the conductive pad 901 may be compressed and partially collapsed as the conductive panel 1401 is forced towards the first electrode 301. As the conductive pad 901 is compressed and partially collapsed, the conductive pad 901 can increase the quality of the electrical connection between the first electrode 301 and the conductive panel 1401 by conforming to any surface abnormalities in the rear face 305 of the first electrode 301 and/or an inner face 1501 of the conductive panel 1401.

As shown by FIGS. 5-7, the rear face 305 of the first electrode 301 may include one or more hanging pins 507 designed to pierce a portion of the thickness of the conductive pad 901 to allow the conductive pad 901 to hang from the first electrode 301 during installation and prior to compression with the conductive panel 1401. In further embodiments, although not shown, the hanging pins 507 may be provided on the rear face of the conductive panel 1401. In some embodiments, the pin can significantly shorter than the thickness of the conductive pad 901, thereby avoiding interference of the hanging pins 507 with the conductive panel 1401 when compressing the conductive pad 901. Still further, in some embodiments, hanging pins may not be provided.

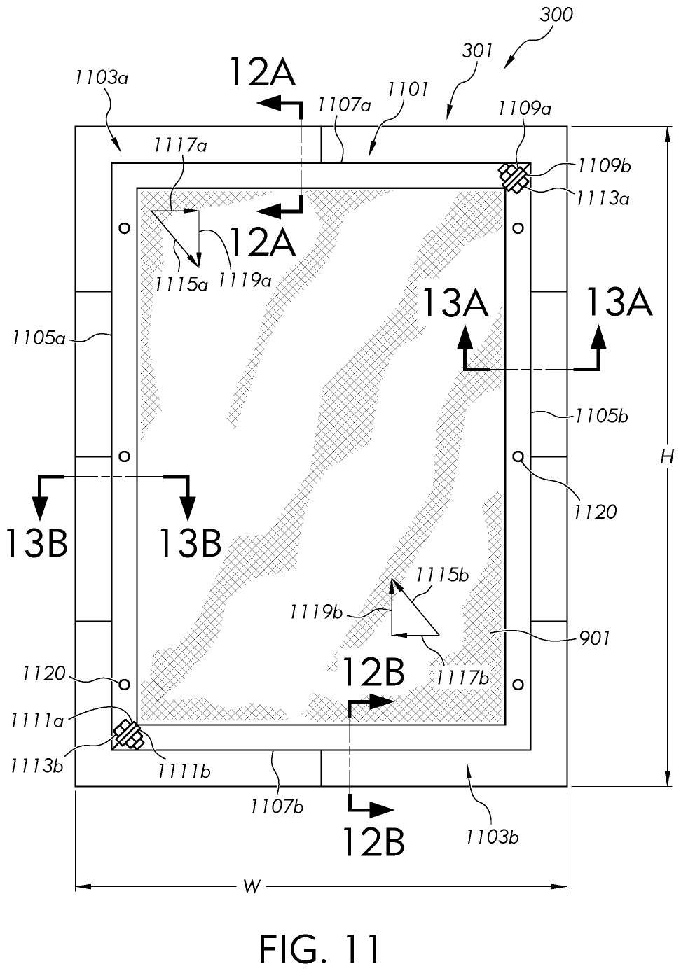

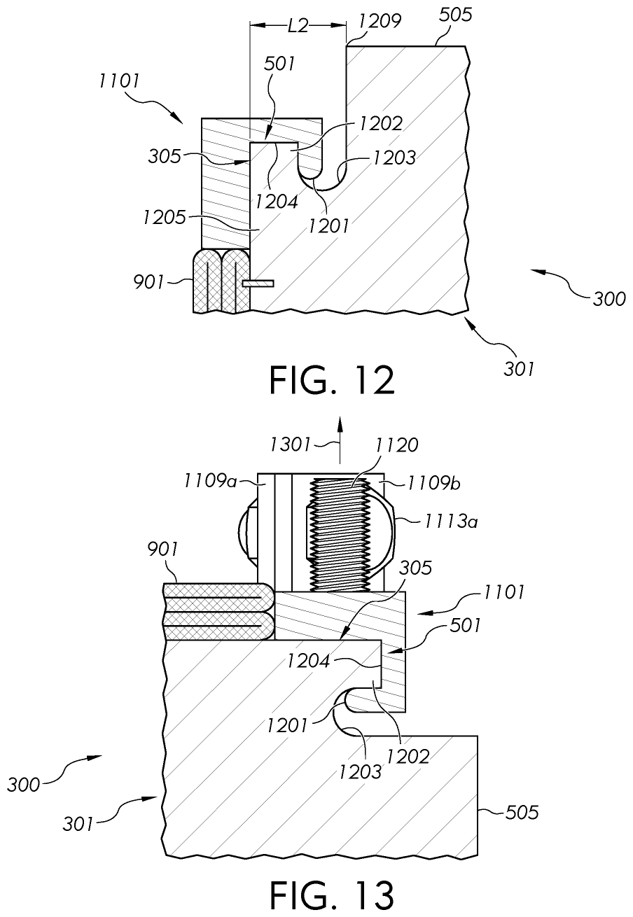

In some embodiments, as shown in FIGS. 11-13, the heating device 300 can comprise a bracket 1101 clamped to the rear end portion 501 of the first electrode 301. The bracket 1101 can comprise at least two segments that are adjustably fastened together to clamp the bracket 1101 to the rear end portion 501 of the first electrode 301. For instance, the bracket 1101 can include four or more segments that are connected together with fasteners. Alternatively, to reduce parts and time assembling, as shown in FIG. 11, the bracket 1101 can comprise a first segment 1103a and a second segment 1103b that can each include a first portion 1105a, 1105b that each extend in a direction of the height “H” of the first electrode 301 and a second portion 1107a, 1107b that each extend in a direction of the width “W” of the first electrode 301. As shown, the first portion 1105a and second portion 1107a of the first segment 1103a can be integrally formed to one another and extend at a 90° angle relative to one another. Likewise, as shown, the first portion 1105b and second portion 1107b of the second segment 1103b can be integrally formed to one another and extend at a 90° angle relative to one another. In some embodiments, the first segment 1103a can include a first end tab 1109a and a second end tab 1111a and the second segment 1103b can include a first end tab 1109b and a second end tab 1111b. A first fastening device 1113a (e.g., nut and bolt) can fasten the first end tab 1109a of the first segment 1103a to the first end tab 1109b of the second segment 1103b. Likewise, a second fastening device 1113b (e.g., nut and bolt) can fasten the second end tab 1111a of the first segment 1103a to the second end tab 1111b of the second segment 1103b. By tightening the first fastening device 1113a and the second fastening device 1113b together, the bracket 1101 can clamp to the rear end portion 501 of the electrode 301 to compress the clamped area 1205 (see FIG. 12) in a direction of the height “H” of the first electrode 301 as well as the width “W” of the first electrode 301. Such clamping action can compress the individual electrode blocks together in both the width direction and the height direction of the electrode. Although not shown, in an alternative embodiment, the two segments may be both split along the height or along the width. For example, the two segments may be both split along the width, wherein tightening of the fastening devices could compress the clamped area in a direction of the width of the electrode. Alternatively, the two segments may be both split along the height, wherein tightening of the fastening devices could compress the clamped area in a direction of the height of the electrode. Furthermore, although the bracket is illustrated with two segments, the bracket may be provided in three or more segments in further embodiments.

As further illustrated in FIGS. 12 and 13, the bracket 1101 can optionally be interlocked with the rear end portion 501 of the first electrode 301. Interlocking the bracket with the rear end portion 501 of the first electrode 301 can help secure the bracket 1101 to the first electrode 301 and help prevent inadvertent dismounting of the bracket 1101 from the first electrode 301 when mounting the conductive panel 1401 to the first electrode 301. In some embodiments, the bracket can include one or more pins to be received within one or more corresponding apertures formed in the rear end portion of the first electrode to interlock the bracket with the rear end portion of the first electrode. As shown, in some embodiments, the bracket 1101 can be interlocked with the rear end portion 501 of the electrode by a tongue interlocked with a groove. For instance, one of the bracket 1101 and the rear end portion 501 of the first electrode 301 can comprise tongue and the other of the bracket 1101 and the rear end portion 501 of the electrode can comprise the groove. In some embodiments, the bracket 1101 and the rear end portion 501 of the first electrode 301 can each include a tongue and groove. In one embodiment, as shown in FIGS. 12 and 13, the bracket 1101 can comprise a tongue 1201 that can be received within a groove 1203 defined by the rear end portion 501 of the first electrode 301. Furthermore, the rear end portion 501 of the first electrode 301 can include a tongue 1202 that can be received in a groove 1204 defined by the bracket 1101.

As shown in FIGS. 12 and 13, the tongue 1201 of the bracket 1101 can comprise a protrusion that may be formed by a flange. In further embodiments, the tongue of the bracket may be formed from a plate that may be a welded or otherwise integrally formed as part of the bracket.

In some embodiments, the groove 1203 can circumscribe the rear end portion 501 of the first electrode 301. For instance, as shown in FIG. 5, the groove 1203 includes a first groove segment 1203a, a second groove segment 1203b, a third groove segment 1203c and a fourth groove segment 1203d that can be arranged end-to-end to circumscribe the rear end portion 501 of the first electrode 301. As further shown in FIG. 5, an outer periphery 509 of the tongue 1202 can further circumscribe the rear end portion 501 of the first electrode 301. For instance, as shown, the tongue 1202 can include a first tongue segment 1202a, a second tongue segment 1202b, a third tongue segment 1202c and a fourth tongue segment 1202d that each include a portion of the outer periphery 509 that circumscribes the rear end portion 501 of the first electrode 301. In some embodiments, the groove 1203 and tongue 1202 may not circumscribe the rear end portion 501 of the first electrode 301. For instance, the groove 1203 may comprise opposed groove segments and the tongue 1202 may comprise opposed tongue segments. In some embodiments, the groove 1203 may comprise two opposed groove segments 1203a, 1203c and the tongue 1202 may comprise two opposed tongue segments 1202a, 1202c. Alternatively, the groove 1203 may comprise two opposed groove segments 1203b, 1203d and the tongue 1202 may comprise two opposed tongue segments 1202b, 1202d. While providing two opposed tongue and groove segments may be beneficial in some embodiments, in some embodiments, providing the illustrated four tongue and groove segments that circumscribe the rear end portion 501 of the first electrode 301 can increase the structural connection between the bracket 1101 and the first electrode 301, reduce stress concentration on the first electrode 301, and help simultaneously compress the blocks in a direction of the height “H” and a direction of the width “W” to properly orient the blocks of the electrode relative to one another.

Referring to FIGS. 6-8, the rear end portion 501 of the first electrode can be considered the portion of the electrode extending rearward in a direction 603 of the length “L1” of the first electrode 301 from the rear peripheral edge 1209 rear peripheral edge 1209 of the outermost profile 505 of the first electrode 301. In some embodiments, the rear end portion 501 can comprise a length “L2” in a direction of the length “L1” of the first electrode 301 that can be within a range of from about 0.5 cm to about 8 cm, such as from about 1 cm to about 5 cm, such as from about 1 cm to about 2.5 cm. Providing the length “L2” of the rear end portion 501 that is less than or equal to 8 cm, such as less than 5 cm, such as less than 2.5 cm, such as less than 1 cm can maximize length of the electrode available for use and therefore maximizes the life of the electrode. Furthermore, providing the length “L2” of the rear end portion 501 that is greater than or equal to 0.5 cm can provide sufficient material to be clamped by the bracket 1101 without damaging the electrode blocks.

To clamp the bracket 1101 to the rear end portion 501 of the first electrode 301, the first and second fastening devices 1113a, 1113b can be tightened such that the corresponding tongues and grooves can be clamped together with a clamped area 1205 therebetween that is located within the length “L2” of the rear end portion 501. Referring to FIG. 11, due to the diagonal split of the bracket 1101 relative to the rectangular rear face 305 of the rear end portion 501, clamping by the bracket 1101 compresses the first segment 1103a and the second segment 1103b together in relative directions 1115a, 1115b. As shown, the relative directions 1115a, 1115b can extend substantially parallel to the rear face 305 of the rear end portion 501, whereby the first segment 1103a and the second segment 1103b can comprise translating jaws that move in the relative directions 1115a, 1115b to laterally clamp down on the rear end portion 501 of the first electrode 301. As such, the first portions 1105a, 1105b of the segments 1103a, 1103b can apply corresponding compressive forces 1117a, 1117b in opposite directions of the width “W” of the first electrode 301. Furthermore, second portions 1107a, 1107b of the segments 1103a, 1103b can apply corresponding compressive forces 1119a, 1119b in opposite directions of the height “H” of the first electrode 301.

As shown in FIGS. 11 and 13, the bracket 1101 can further include an anchor, such as the illustrated threaded anchor 1120. As shown in FIG. 13, in some embodiments, the threaded anchor 1120 can extend outwardly in direction 1301 that can be perpendicular to the rear face 305 of the first electrode 301 when the bracket 1101 is clamped to the first electrode 301. In some embodiments, each of the first portions 1105a, 1105b of the segments 1103a, 1103b can include a plurality of threaded anchors 1120 that can be correspondingly space apart from one another along the respective first portions 1105a, 1105b.

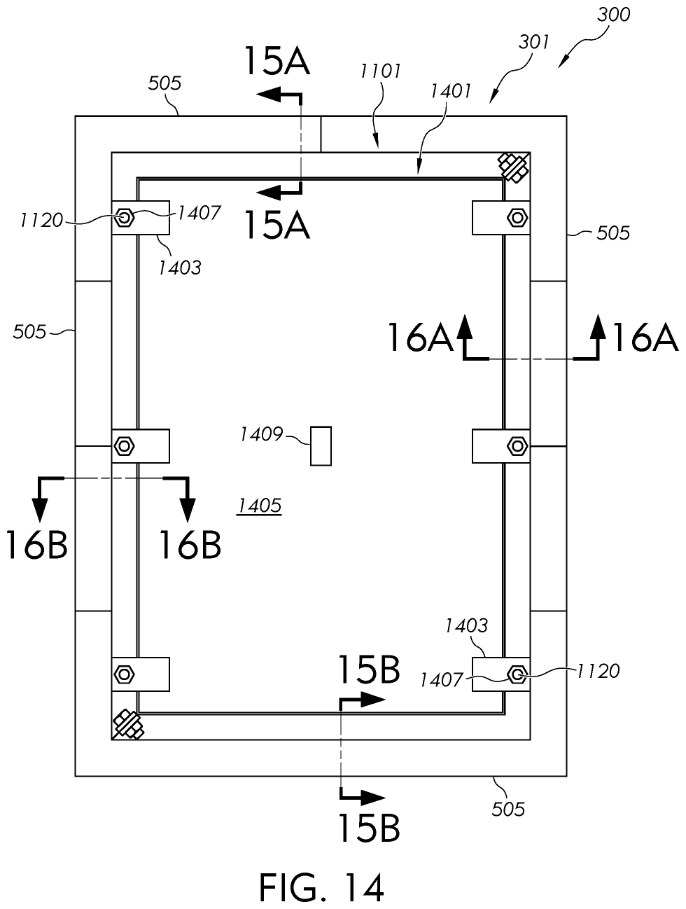

FIGS. 14-16 illustrate an exemplary embodiment of a conductive panel 1401 that can be mounted relative to the first electrode 301 by way of the bracket 1101. As shown in FIGS. 15 and 16, the inner face 1501 of the conductive panel 1401 can be forced (e.g., pushed or pulled) toward the rear face 305 of the first electrode 301 by the bracket 1101. For instance, as shown, the conductive panel 1401 can adjustably fastened to the bracket 1101 to force the inner face 1501 of the conductive panel 1401 toward the rear face 305 of the first electrode 301. In the illustrated embodiment, the conductive panel 1401 can include a plurality of mounting tabs 1403 that may be welded or otherwise attached to the outer face 1405 of the conductive panel 1401. The threaded anchors 1120 can each be inserted in an aperture 1703 (see FIG. 17) of a corresponding mounting tab 1403. Adjustment nuts 1407 can be threadedly received on the threaded anchors 1120 and torqued down against the corresponding mounting tab 1403 to force the inner face 1501 of the conductive panel 1401 towards the rear face 305 of the first electrode 301. In some embodiments, when torquing the adjustment nut 1407, as shown in FIGS. 15-16, the conductive pad 901 (e.g., 4-ply silver mesh) may be at least partially collapsed under compressive forces applied by the inner face 1501 of the conductive panel 1401 and the rear face 305 of the first electrode 301. The conductive pad 901 conforms to any surface irregularities of the inner face 1501 of the conductive panel 1401 and the rear face 305 of the first electrode 301 as the conductive pad 901 partially collapses; thereby enhancing the electrical connection between the first electrode 301 and the conductive panel 1401.

As shown in FIGS. 14-16, once the adjustment nuts 1407 are torqued down, the bracket 1101 grips the rear end portion 501 of the first electrode 301 within the length “L2”, thereby preserving a significantly large portion of the overall length “L1” of the first electrode 301 for use to heat molten material 121 within the vessel. Furthermore, the bracket 1101 can act to force the inner face 1501 of the conductive panel 1401 toward the rear face 305 of the first electrode 301 to enhance the electrical connection between the first electrode 301 and the conductive panel 1401. Referring to FIG. 14, a lug 1409 may be welded or otherwise attached to the outer face 1405 of the conductive panel 1401 to act as a terminal to connect with the first electrical lead 307 (see FIG. 3). In use, electricity may be introduced by the electrical lead 307, through the lug 1409 and into the conductive panel 1401. Electricity then travels from the conductive panel 1401, through the conductive pad 901 and through the rear face 305 and into the first electrode 301. As shown in FIGS. 3-4, electric current 325 passes through the molten material 121, through the second electrode 302 and out the second electrical lead 308, thereby heating the molten material as the electric current 325 passes through the molten material 121 between the electrodes 301, 302.

The conductive panel 1401 can comprise a wide range of conductive materials, such as metal (e.g., stainless steel, nickel). To prevent overheating, in some embodiments, the conductive panel 1401 may be cooled in use. For instance, referring to FIG. 14, cooled fluid (e.g., gas or liquid) may be passed over the outer face 1405 to cool the conductive panel 1401 in use.

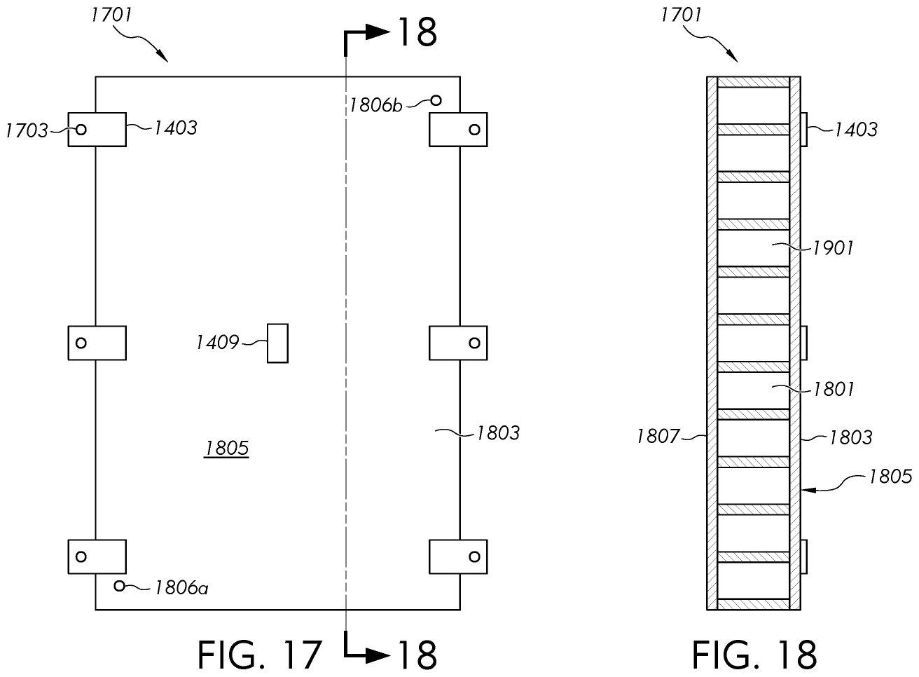

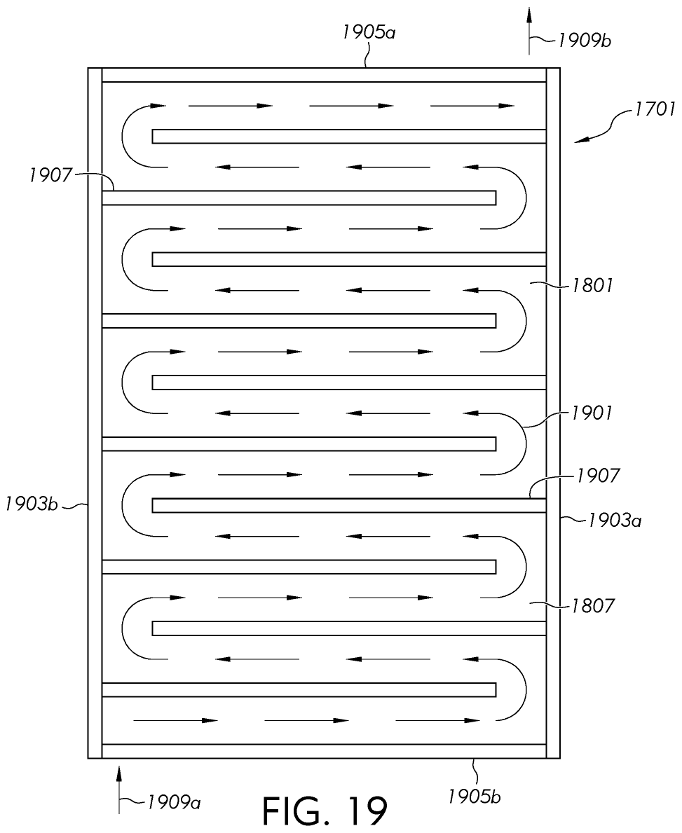

FIGS. 17-19 illustrate another embodiment of a conductive panel 1701 that can optionally be used in the place of the conductive panel 1401 discussed above. As shown in FIGS. 18-19, the conductive panel 1701 comprises a fluid coolant path 1901 extending through an interior 1801 of the conductive panel 1701. As shown in FIG. 18, in some embodiments, the conductive panel 1701 can include an outer plate 1803 defining an outer face 1805 of the conductive panel 1701. A fluid inlet port 1806a can provide fluid communication with a lower portion of the fluid coolant path 1901 and a fluid outlet port 1806b can provide fluid communication with an upper portion of the fluid coolant path 1901. In some embodiments, providing the fluid outlet port 1806b at the upper portion of the fluid coolant path 1901 can help inadvertent draining of fluid from the interior area 1801 due to a leak or other loss of fluid at the fluid outlet port 1806b or at a conduit, joint or other location downstream from the fluid outlet port 1806b.

The conductive panel 1701 can further include an inner plate 1807 spaced from the outer plate 1803 to define the interior area 1801 of the conductive panel 1701. FIG. 19 illustrates the conductive panel 1701 of FIG. 17 with the outer plate 1803 removed to illustrate the serpentine cooling path 1901 that may be defined within the interior area 1801 of the conductive panel 1701. As shown, in some embodiments, the outer periphery of the conductive panel 1701 may include side walls 1903a, 1903b and end walls 1905a, 1905b welded or otherwise sealed at interfaces with the outer plate 1803 and inner plate 1807. A plurality of interior baffles 1907 may be further welded or otherwise sealed at the interfaces with the outer plate 1803 and inner plate 1807 to define the serpentine cooling path 1901. In operation, fluid (e.g., liquid, gas) may be passed in through the fluid inlet port 1806a as indicated by arrow 1909a. The fluid may then travel upward through the serpentine cooling path 1901 to the fluid outlet port 1806b as indicated by arrow 1909b. The fluid may then exit the fluid outlet port 1806b. In some embodiments, a fluid circuit may connect the fluid outlet port 1806b to the fluid inlet port 1806a where a heat exchanger may remove heat from the fluid and then circulate the fluid back to the fluid inlet port 1806a to again cool the conductive panel 1701.

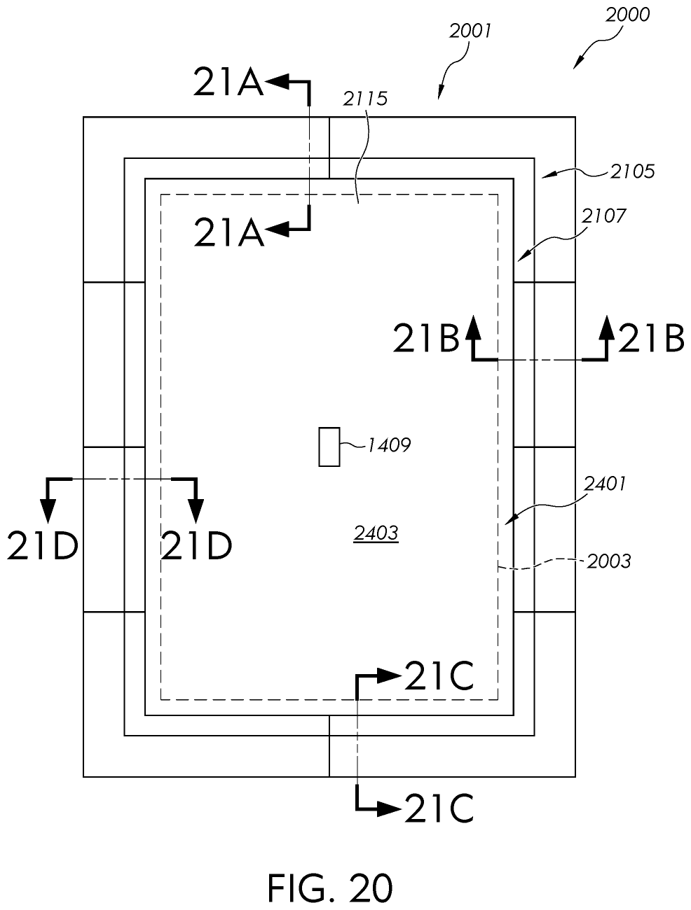

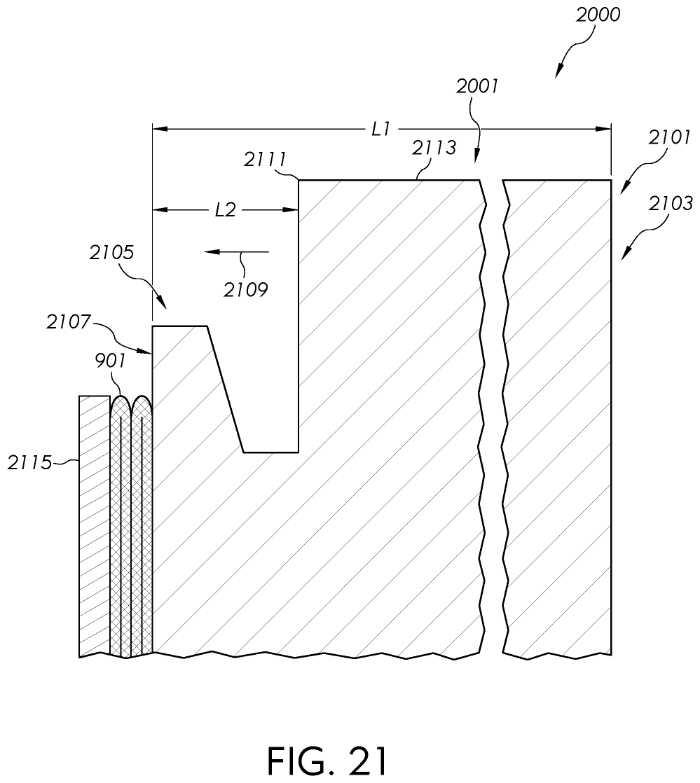

FIGS. 20-24 illustrate a heating device 2000 in accordance with further exemplary embodiments of the present disclosure. The heating device 2000 can include an electrode 2001 that can comprise a front end portion 2101 comprising a front face 2103. As further illustrated in FIG. 21, the electrode 2001 can include a rear end portion 2105 comprising a rear face 2107 and the length “L1” extending between the front face 2103 and the rear face 2107 as discussed above with respect to the first electrode 301.

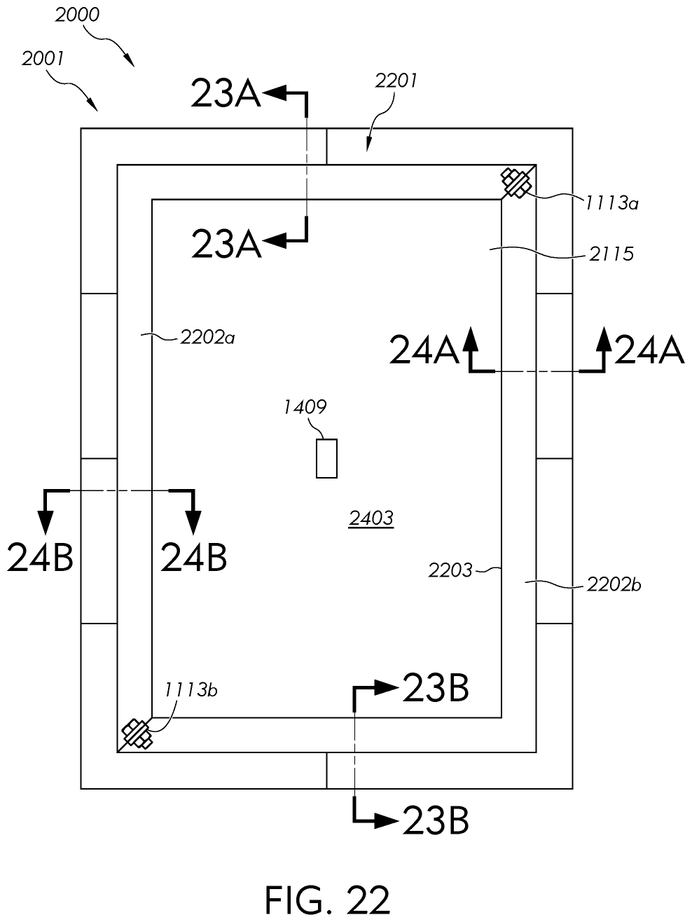

Referring to FIG. 21, the rear end portion 2105 of the electrode 2001 can be considered the portion of the electrode 2001 extending rearward in a direction 2109 of the length “L1” of the electrode 2001 from the rear peripheral edge 2111 of the outermost profile 2113 of the electrode 2001. In some embodiments, the rear end portion 2105 can comprise a length “L2” in a direction of the length “L1” of the electrode 2001 that may be within a range of from about 0.5 cm to about 8 cm, such as from about 1 cm to about 5 cm, such as from about 1 cm to about 2.5 cm. Providing the length “L2” of the rear end portion 2105 that is less than or equal to 8 cm, such as less than 5 cm, such as less than 2.5 cm, such as less than 1 cm can maximize length of the electrode available for use and therefore maximizes the life of the electrode. Furthermore, providing the length “L2” of the rear end portion 2105 that is greater than or equal to 0.5 cm can provide sufficient material to be clamped by a bracket 2201 (see FIG. 22) without damaging the electrode blocks.

FIG. 21 illustrates the conductive pad 901 that may be positioned adjacent the rear face 2107 of the electrode 2001 and a conductive panel 2115 positioned adjacent the conductive pad 901 with the conductive pad 901 positioned between the rear face 2107 of the electrode 2001 and the conductive panel 2115. Like the conductive panel 1701 discussed above, the conductive panel 2115 can optionally include a fluid coolant path extending through an interior of the conductive panel.

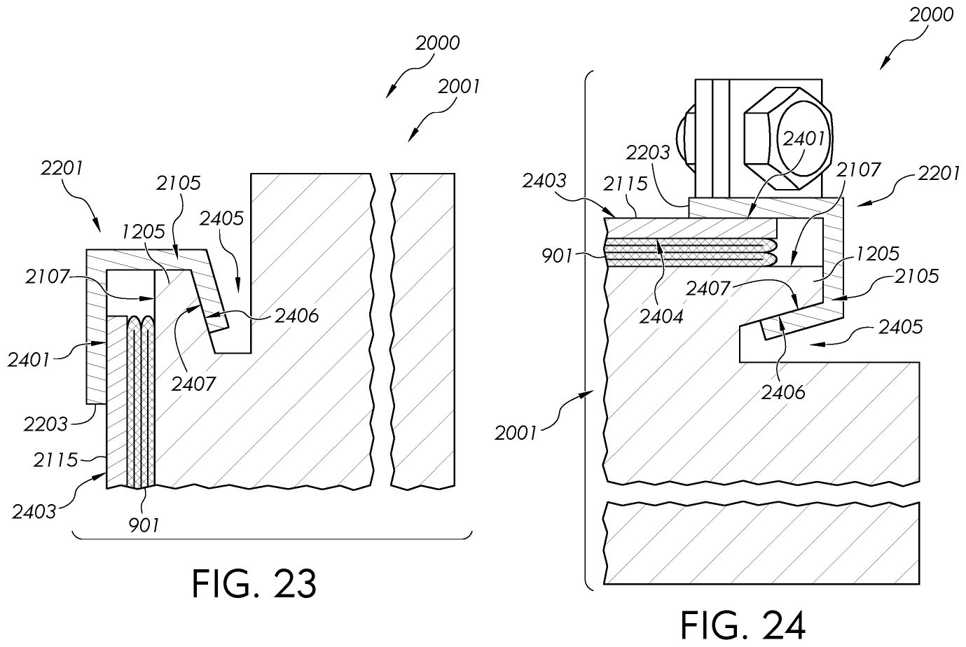

FIGS. 22-24 illustrate the bracket 2201 clamped to the rear end portion 2105 of the electrode 2001 to engage an outer surface periphery 2401 of an outer face 2403 of the conductive panel 2115 to force the conductive panel 2115 toward the rear face 2107 of the electrode 2001. The dashed lines 2003 in FIG. 20 represent a location of an edge 2203 of the bracket 2201 extending over the outer face 2403 of the conductive panel 2115 once clamped in place. As such, as shown in FIG. 20, in some embodiments, the outer surface periphery 2401 of the outer face 2403 can circumscribe a central area of the outer face 2403 to allow clamping about the periphery of the conductive panel 2115 in some embodiments. Similar to the bracket 1101 discussed above, in some embodiments, the bracket 2201 can include at least two segments 2202a, 2202b that can be clamped together with fastening devices 1113a, 1113b to clamp the bracket 2201 to the rear end portion 2105 of the electrode 2001. However, as shown in FIGS. 23 and 24, the groove 2405 of the electrode can include an inclined surface 2406 that can mate with an inclined surface 2407. As such, due to the ramped nature of the mating inclined surfaces 2406, 2407, tightening of the segments with the fastening devices simultaneously clamps the bracket against the electrode while also compressing the conductive pad 901 with the conductive panel 2115 such that the conductive pad 901 at least partially collapses while the inner face 2404 of the conductive panel 2115 is forced toward the rear face 2107 of the electrode 2001 by the bracket 2201.

A method of assembling the heating device 300, 2000 can comprise clamping the bracket 1101, 2201 to the rear end portion 501, 2105 of the electrode 301, 2001. In some embodiments, the bracket clamps (e.g., only clamps) the rear end portion at a clamped area 1205 that may be within the length “L2” of the rear end portion 501, 2105. In some embodiments, the length “L2” of the rear end portion 501, 2105 can be less than or equal to 8 cm from the rear face 305, 2107 of the electrode 301, 2001. In further embodiments, as discussed above, the length “L2” can be within a range of from about 0.5 cm to about 8 cm, such as from about 1 cm to about 5 cm, such as from about 1 cm to about 2.5 cm. Providing the length “L2” of the rear end portion 2105 that is less than or equal to 8 cm, such as less than 5 cm, such as less than 2.5 cm, such as less than 1 cm can maximize length of the electrode available for use and therefore maximizes the life of the electrode.

The method of assembling the heating device 300, 2000 can comprise forcing the inner face 1501, 2404 of the conductive panel 1401, 2115 toward the rear face 305, 2107 of the electrode 301, 2001 with the bracket 1101, 2201. With respect to the heating device 300, with the bracket 1101 already clamped to the rear end portion 501 of the first electrode 301, the adjustment nuts 1407 can be tightened to force the inner face 1501 of the conductive panel 1401 toward the rear face 305 of the first electrode 301. With respect to the heating device 2000, the fastening devices 1113a, 1113b can be tightened such that the two segments 2202a, 2202b of the bracket 2201 clamp the bracket 2201 to the rear end portion 2105 of the electrode 2001 while simultaneously forcing of the inner face 2404 of the conductive panel 2115 toward the rear face 2107 of the electrode 2001. In either case, the forcing of the inner face 1501, 2404 of the conductive panel 1401, 2115 toward the rear face 305, 2107 of the electrode 301, 2001 can at least partially collapse the conductive pad 901 to provide enhanced electrical contact with the rear face 305, 2107 of the electrode 301, 2001 and the inner face 1501, 2404 of the conductive panel 1401, 2115.

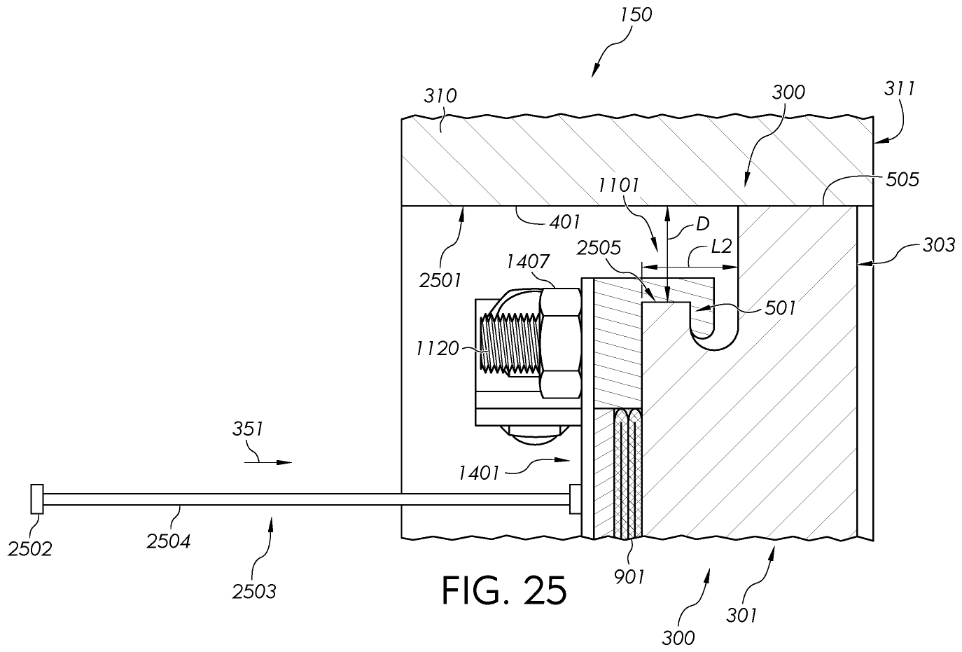

FIG. 25 illustrates a portion of an exemplary melting vessel 105 of the glass manufacturing apparatus 100. Any of the heating devices of the disclosure can be received at least partially within the opening (e.g, first opening 401) of the wall 310 of the melting vessel 105. For instance, as shown, at least a portion or the entire first electrode 301, at least a portion or the entire bracket 1101, at least a portion or the entire conductive panel 1401, and at least a portion or the entire conductive pad 981 can be received (e.g., entirely received) within the first opening 401 of the wall 310. Indeed, as mentioned previously, the first electrode 301 can comprise a cross-sectional footprint defined by an outermost profile 505 of the electrode along a section taken perpendicular to the length “L1” of the first electrode 301. As shown in FIG. 14, the bracket 1101 and the conductive panel 1401 can each be located entirely within the projection of the footprint of the first electrode 301 in a direction of the length “L1” of the first electrode 301. As such, as shown in FIG. 25, the outermost profile 505 of the first electrode 301 closely follows an inner surface 2501 defining the opening 401 to allow axial movement of the heating device 300 in direction 351 relative to the opening 401. As the bracket 1101 and conductive panel 1401 are each located entirely within the projection of the footprint of the first electrode 301, the bracket 1101 and the conductive panel 1401 can be entirely received within the first opening 401 of the wall 310 without mechanical interference with the first opening 401.

Furthermore, an outer peripheral edge 2505 of the rear end portion 501 may be recessed a depth “D” from the outermost profile 505 of the first electrode 301. The depth “D” can be sufficient to accommodate the bracket 1101, conductive panel 1401 and/or other portions of the heating device 300. Furthermore, the depth “D” can be sufficient to allow removal of the bracket 1101 from the first electrode 301 while the bracket 1101 is located within the first opening 401 of the wall 310 without mechanical interference with the first opening 401.

As shown in FIG. 4, a method of using the glass manufacturing apparatus 100 can include heating molten material 121 within the containment area 315 of the vessel (e.g., melting vessel 105) by passing electrical current 325 through the molten material 121 with the electrodes 301, 302. The electrodes 301, 302 tend to wear over time. For instance, the electrodes 301, 302 tend to be heated to a higher temperature than surrounding refractory material wall 310. As such, the electrodes 301, 302 may wear, and in some embodiments, wear faster than the refractory material wall 310. In some embodiments, where the walls 310 are constructed with zirconia bricks and the electrodes 301, 302 constructed with tin oxide, the electrodes tend to wear at a higher rate than the zirconia bricks.

To accommodate for the wear of the electrodes, the electrodes 301, 302 may be adjusted in respective directions 351, 352 relative to the openings 401, 402 within the wall 310. For instance, as shown schematically in FIG. 25, adjustment of the first electrode 301 can be achieved with a mechanism 2503 including an actuator 2502 (e.g., threaded connection, hydraulic cylinder) and a pressure member such as the illustrated rod 2504. The actuator 2502 can cause the rod 2504 to press against a rear portion of the heating device 300 to cause movement of the heating device 300 in the direction 351 relative to the first opening 401 in the wall 310.

As the rear end portion 501 can include a relatively short length “L2”, the first electrode 301 may be adjusted a significant portion of the overall length “L1” before a new electrode should be positioned to continue further heating of molten material within the vessel. Features of the present disclosure may allow quick introduction of a new electrode without interrupting the glass formation process; thereby avoiding deactivating the glass manufacturing process that may otherwise be necessary to replace the electrodes. For instance, referring to FIG. 25, the mechanism 2503 can be disengaged from the heating device 300 or otherwise removed from the vicinity of the heating device 300. The adjustment nuts 1407 may be loosened and removed from the threaded anchor 1120. The conductive panel 1401 and conductive pad 901 may be removed. Next, the depth “D” can be sufficient to allow dilation of the bracket 1101 to unclamp and remove the bracket 1101 from the rear end portion 501 or detach the first and second segments 1103a, 1103b to permit removal of the first and second segments.

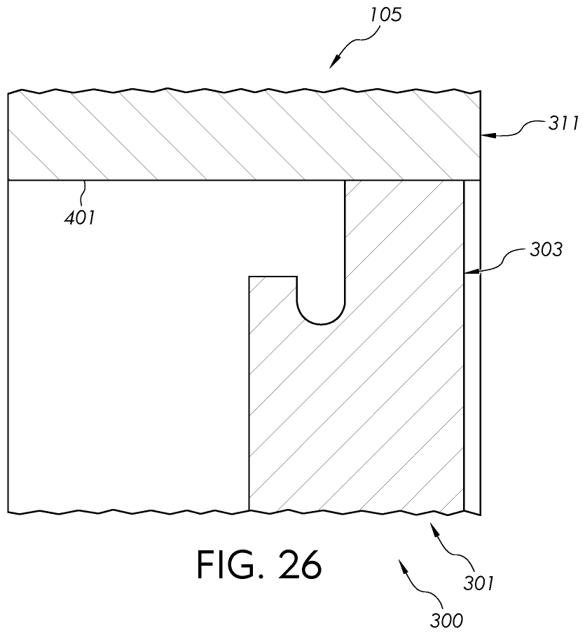

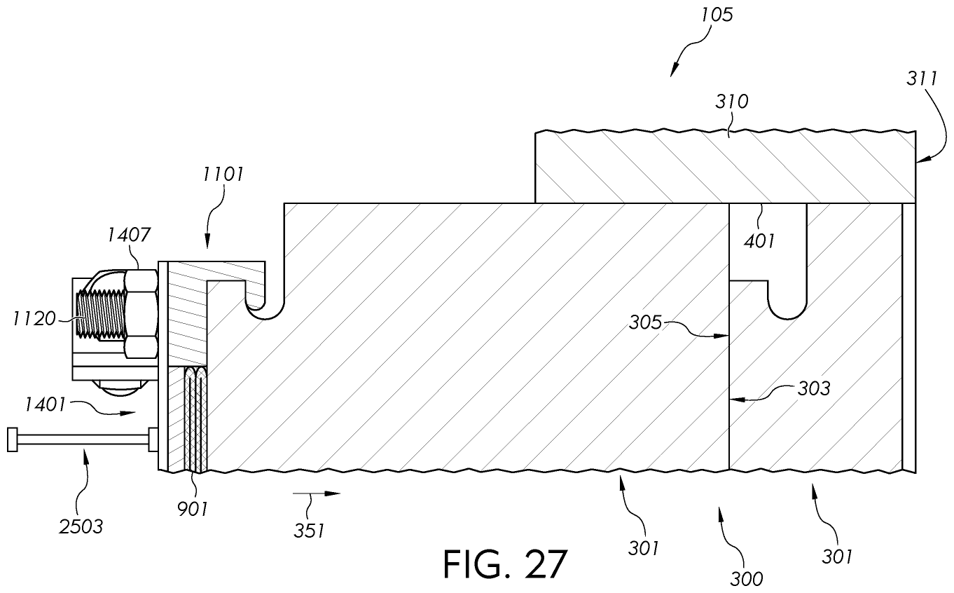

Once removed, the first electrode 301 can remain in place as illustrated in FIG. 26. As shown in FIG. 27, another electrode 301 can be at least partially inserted into the first opening 401 and pressed against the adjusted electrode 301 to further adjust the position of the adjusted electrode 301 relative to the opening of the wall 310. Indeed, the mechanism 2503 can press the front face 303 of another electrode 301 against the rear face 305 of the adjusted electrode 301 to further adjust the position of the electrode in the direction 351 relative to the opening 401 of the wall 310. As such, further adjustments can be made until the leading electrode 301 is completely worn away and then the new electrode 301 begins operating to directly heat the molten material. In some embodiments, the process can be repeated to continually replenish depleted electrodes with a new electrode without interrupting the manufacturing process.

Embodiments and the functional operations described herein can be implemented in digital electronic circuitry, or in computer software, firmware, or hardware, including the structures disclosed in this specification and their structural equivalents, or in combinations of one or more of them. Embodiments described herein can be implemented as one or more computer program products, i.e., one or more modules of computer program instructions encoded on a tangible program carrier for execution by, or to control the operation of, data processing apparatus. The tangible program carrier can be a computer readable medium. The computer readable medium can be a machine-readable storage device, a machine-readable storage substrate, a memory device, or a combination of one or more of them.

The term “processor” or “controller” can encompass all apparatus, devices, and machines for processing data, including by way of example a programmable processor, a computer, or multiple processors or computers. The processor can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes described herein can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit) to name a few.

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more data memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), to name just a few.

Computer readable media suitable for storing computer program instructions and data include all forms data memory including nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments described herein can be implemented on a computer having a display device, e.g., a CRT (cathode ray tube) or LCD (liquid crystal display) monitor, and the like for displaying information to the user and a keyboard and a pointing device, e.g., a mouse or a trackball, or a touch screen by which the user can provide input to the computer. Other kinds of devices can be used to provide for interaction with a user as well; for example, input from the user can be received in any form, including acoustic, speech, or tactile input.

Embodiments described herein can be implemented in a computing system that includes a back end component, e.g., as a data server, or that includes a middleware component, e.g., an application server, or that includes a front end component, e.g., a client computer having a graphical user interface or a Web browser through which a user can interact with implementations of the subject matter described herein, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

It is also to be understood that, as used herein the terms “the,” “a,” or “an,” mean “at least one,” and should not be limited to “only one” unless explicitly indicated to the contrary. Likewise, a “plurality” is intended to denote “more than one.”

Ranges can be expressed herein as from “about” one particular value, and/or to “about” another particular value. When such a range is expressed, embodiments include from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

The terms “substantial,” “substantially,” and variations thereof as used herein are intended to note that a described feature is equal or approximately equal to a value or description.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to an apparatus that comprises A+B+C include embodiments where an apparatus consists of A+B+C and embodiments where an apparatus consists essentially of A+B+C.

It will be apparent to those skilled in the art that various modifications and variations can be made to the present disclosure without departing from the spirit and scope of the appended claims. Thus, it is intended that the present disclosure cover the modifications and variations of the embodiments herein provided they come within the scope of the appended claims and their equivalents.

1. A heating device comprising:
an electrode comprising a front end portion comprising a front face, a rear end portion comprising a rear face, and a length extending between the front face and the rear face;
a bracket clamped to the rear end portion of the electrode; and
a conductive panel comprising an inner face forced toward the rear face of the electrode by the bracket.

2. The heating device of claim 1, wherein the bracket comprises at least two segments that are adjustably fastened together to clamp the bracket to the rear end portion of the electrode.

3. The heating device of claim 1, wherein the bracket is interlocked with the rear end portion of the electrode.

4. The heating device of claim 1, wherein the bracket is interlocked with the rear end portion of the electrode by a tongue interlocked with a groove, and one of the bracket and the rear end portion of the electrode comprises the tongue and the other of the bracket and the rear end portion of the electrode comprises the groove.

5. The heating device of claim 1, wherein the bracket clamps the rear end portion at a clamped area that is entirely located less than or equal to 8 cm from the rear face of the electrode.

6. The heating device of claim 1, wherein a conductive pad is forced against the rear face of the electrode by the inner face of the conductive panel.

7. The heating device of claim 1, wherein the electrode comprises a cross-sectional footprint defined by an outermost profile of the electrode along a section taken perpendicular to the length of the electrode, and the bracket and the conductive panel are each located entirely within a projection of the footprint of the electrode in a direction of the length of the electrode.

8. The heating device of claim 1, wherein the conductive panel is adjustably fastened to the bracket to force the inner face of the conductive panel toward the rear face of the electrode.

9. The heating device of claim 1, wherein the conductive panel comprises a fluid coolant path extending through an interior of the conductive panel.

10. A method of assembling the heating device of claim 1 comprising:
clamping the bracket to the rear end portion of the electrode; and
forcing the inner face of the conductive panel toward the rear face of the electrode with the bracket.

11. The method of claim 10, wherein the bracket clamps the rear end portion at a clamped area that is entirely located less than or equal to 8 cm from the rear face of the electrode.

12. The method of claim 10, wherein the forcing of the inner face of the conductive panel toward the rear face of the electrode at least partially collapses a conductive pad contacting the rear face of the electrode and the inner face of the conductive panel.

13. The method of claim 10, wherein the electrode comprises a cross-sectional footprint defined by an outermost profile of the electrode along a section taken perpendicular to the length of the electrode, and the bracket and the conductive panel are each located entirely within a projection of the footprint of the electrode in a direction of the length of the electrode.

14. An apparatus comprising the heating device of claim 1 comprising:
a vessel comprising at least one wall defining a containment area of the vessel, the at least one wall comprising an opening receiving at least a portion of the electrode.

15. The apparatus of claim 14, wherein a position of the electrode is adjustable relative to the opening of the wall.

16. The apparatus of claim 14, wherein the frame and the conductive panel are received within the opening of the wall.

17. The apparatus of claim 14, wherein the vessel comprises a melting vessel of a glass manufacturing apparatus.

18. A method of using the apparatus according to claim 14, the method comprising:
heating molten material within the containment area of the vessel by passing electrical current through the molten material with the electrode; and
adjusting a position of the electrode relative to the opening of the wall.

19. The method of claim 18, wherein the frame and the conductive panel are both positioned within the opening of the wall while adjusting the position of the electrode relative to the opening of the wall.

20. The method of claim 18, further comprising removing the frame and the conductive panel from the adjusted electrode, and then pressing another electrode against the adjusted electrode to further adjust the position of the adjusted electrode relative to the opening of the wall.
